(19) United States
(12) Patent Application Publication
(10) Pub. No.: US 2026/0338912 A1
(43) Pub. Date: Oct. 29, 2026

(54) AN FMCW RADAR SYSTEM WITH INCREASED CAPACITY

(71) Applicant: Magna Electronics Sweden AB, Vårgårda (SE)

(72) Inventors: Jonathan MOSS, Unterschleissheim (DE); Michael KRITZNER, Niederwerrn (DE); Andreas LEFEVRE, Niederwerrn (DE)

(21) Appl. No.: 19/110,292

(22) PCT Filed: Sep. 7, 2023
(86) PCT No.: PCT/EP2023/074573

§ 371 Date: Mar. 10, 2025

(30) Foreign Application Priority Data
Sep. 13, 2022 (SE) 2251059-8

(51) Int. Cl. G01S 7/02; G01S 7/35; G01S 13/931

(52) U.S. Cl. CPC G01S 7/0232; G01S 7/35; G01S 13/931

(57) ABSTRACT

The present disclosure relates to a vehicle radar system (210; 210A, 210B, 210C) comprising a control unit (208) and at least one radar transceiver arrangement (201, 202, 203, 204, 205) arranged to generate and transmit an FMCW signal (220) in a radar frequency band. Each FMCW signal (220) comprises a corresponding plurality of ego frequency ramps (r; rₐ, r_{b}, r_{c}, r_{d}, rₑ) that are generated in radar cycles having a certain ego cycle time (to) and ego cycle start time (t_{cs}; t_{csa}, t_{csb}, t_{csc}, t_{csd}, t_{cse}), where each one of the ego frequency ramps (r; rₐ, r_{b}, r_{c}, r_{d}, rₑ) has a certain ego duration time (tᵣ), an ego delay time (t_{D}) between adjacent ego frequency ramps (r) and an ego frequency gradient (df/dt). The control unit (208) is adapted to receive synchronization information from at least one external unit (400, 420, 430, 450; 208A, 208B, 208C; 460), and to base at least the ego cycle start time (t_{cs}; t_{csa}, t_{csb}, t_{csc}, t_{csd}, t_{cse}), the ego duration time (tᵣ) and the ego delay time (t_{D}) on the synchronization information.

### CROSS REFERENCE TO RELATED APPLICATIONS

This application is a 35 U.S.C. § 371 national phase of PCT International Application No. PCT/EP 2023/074573, filed Sep. 7, 2023, which claims the benefit of priority under 35 U.S.C. § 119 to Swedish Patent Application No. 2251059-8, filed Sep. 13, 2022, the contents of which are incorporated herein by reference in their entirety.

### DESCRIPTION OF THE DISCLOSURE

The present disclosure relates to radar systems adapted for automotive applications. There are disclosed radar systems and methods for operating radar systems.

A radar transceiver is, normally, a device arranged for transmission and reception of radar signals in a dedicated radar frequency band. Radar transceivers are commonly used in vehicles for monitoring vehicle surroundings. Automatic Cruise Control (ACC) functions, Emergency Braking (EB) functions, Advanced Driver Assistance Systems (ADAS) and Autonomous Drive (AD) are some examples of applications where radar data represents an important source of information on which vehicle control is based.

Many of the dedicated automotive radar frequency bands allow uncoordinated transmission, which means that two or more radar transceivers may transmit at the same time in the same frequency band, and thus interfere with each other.

EP 3244229 discussed the general effects of interference on a frequency modulated continuous wave (FMCW) radar system, and proposed methods to repair an interfered radar signal.

Despite the often impressive efficiency of previously proposed repair methods, there is a need for further improvements in vehicular radar systems in order to reduce interference, and possibly to provide a lower cost means of avoiding interference for radar transceivers.

### SUMMARY

It is an object of the present disclosure to provide improved vehicle radar systems where interference is reduced or removed entirely, compared to known vehicular radar systems, such as uncoordinated automotive radar based on uncoordinated FMCW transmission.

This object is obtained by a vehicle radar system comprising a control unit and at least one radar transceiver arrangement arranged to generate and transmit an FMCW, Frequency Modulated Continuous Wave, signal in a radar frequency band and to receive reflected signals that have been reflected by one or more target objects. Each FMCW signal comprises a corresponding plurality of ego frequency ramps that are generated in radar cycles having a certain ego cycle time and ego cycle start time. Each one of the ego frequency ramps has a certain ego duration time, an ego delay time between adjacent ego frequency ramps and an ego frequency. The control unit is adapted to receive synchronization information from at least one external unit, and to base at least the ego cycle start time, the ego duration time and the ego delay time on the synchronization information.

In this way, the vehicle radar system may adapt the ego cycle start time, the ego duration time and the ego delay time such that interference is minimized, while enabling frequency ramps from other radar systems to be interleaved in a non-interfering manner.

According to some aspects, the ego frequency gradient df/dt is based on the synchronization information.

This means that all radar transceivers adopt to a common frequency gradient or slope of their FMCW transmissions. When this common frequency gradient is used by other radar systems in other vehicles, it is possible to avoid that the frequency ramps cross but can run in an interleaved non-interfering manner.

According to some aspects, the synchronization information comprises time reference data, where the control unit is adapted to control the ego cycle start time in dependence of the time reference data.

By using an externally derived timing reference, all radar systems within an area can maintain the same slope gradient as well as fixed starting frequencies. By defining a set of fixed starting times, for example at 2 μs intervals one can define a set of “timeslots”. The timeslots would be defined by their start time and starting frequency. The periodicity would be fixed, for example at 64 μs such that a block of chirps all occupying the same timeslot could be sent and in such an example there would be 32 timeslots to choose from. Different radar transceivers around the vehicle and in neighbouring vehicles can select a timeslot to avoid interference. An external observer would see all radar transceivers operating at the same time and in the same band, in an interleaved pattern.

According to some aspects, the synchronization information comprises a frequency reference, where the control unit is adapted to control at least one radar transceiver arrangement to generate ego frequency ramps in dependence of the frequency reference.

The use of external frequency reference would ensure that the chirp or frequency ramp gradient is maintained precisely as if the gradient or timing is slightly wrong then over the course of multiple chirps two chirp signals may become too close together and cause interference.

According to some aspects, the synchronization information comprises information regarding at which times neighboring radar transceivers are transmitting neighboring frequency ramps and with which neighboring frequency gradient. The control unit is adapted to control the ego frequency gradient to correspond to the synchronization information and to schedule the ego frequency ramps in free timeslots between the neighboring frequency ramps.

This further adds to enabling the frequency ramps to run in an interleaved non-interfering manner.

According to some aspects, the control unit is adapted to control at least one radar transceiver arrangement to monitor a certain part of the radar frequency band during an observation period, to analyze possible interference signals. The control unit is further adapted to identify a certain start time to start sending a cycle of one or more ego frequency ramps in dependence of said analysis, such that interference from said interference signals is reduced.

The radar frequency band can thus be monitored to determine which timeslots that are occupied and which are free. The control unit may then control the radar transceiver arrangements to transmit on that timeslot for one or more radar cycles, periodically checking that the timeslot is still free.

According to some aspects, each radar transceiver arrangement is associated with a main pointing direction and a pre-defined set of timeslots 0 . . . N, where each timeslot TS_{0.N} corresponds to a sequence of ego frequency ramps within a frame and the timeslot number corresponds to a time offset.

The control unit is adapted to define heading intervals which divide a full turn interval 0°-360° into sections, and to assign a corresponding timeslot to each heading interval. The control unit is further adapted to determine a present vehicle heading, and to assign a corresponding timeslot to each one of the radar transceivers in dependence of the heading interval that comprises the present vehicle heading.

This way, those radar transceivers that are most likely to interfere or attract interference are controlled to generate interleaved frequency ramps.

According to some aspects, the radar transceiver arrangements are adapted to transmit a stepped FMCW waveform whereby the radar transceiver arrangements are synchronised such that the corresponding ego frequency ramps are aligned to occupy one timeslot each.

This means that the present disclosure is applicable for stepped frequency ramps as well.

Some vehicle radar systems may use a stepped FMCW radar waveform that only occupy a part of the 1 GHz band for any one frequency ramp. In such stepped FMCW systems, multiple radar transceivers around the vehicle may be transmitting at the same time, but in different parts of the band.

According to some aspects, all stepped FMCW radar transceivers around the vehicle are synchronised in time and frequency such that the radar chirps appear as a near single continuous chirp and hence still occupy a small number of timeslots. This allows regular FMCW and stepped FMCW radar transceivers to avoid interference with each other.

There are also disclosed herein vehicles and methods associated with the above-mentioned advantages.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

Further features of, and advantages with, the present disclosure will become apparent when studying the appended claims and the following description. The skilled person realizes that different features of the present disclosure may be combined to create embodiments other than those described in the following, without departing from the scope of the present disclosure.

### BRIEF DESCRIPTION OF THE DRAWINGS

The present disclosure will now be described in more detail with reference to the appended drawings, where

FIG. 1 schematically illustrates a prior art traffic scenario;

FIG. 2 schematically shows a top view of a vehicle;

FIG. 3 schematically shows a top view of a vehicle with heading intervals;

FIG. 4 schematically shows frequency ramps of an FMCW signal;

FIG. 5 schematically shows ego frequency ramps with interleaved neighbor frequency ramps;

FIG. 6 schematically shows a detail of FIG. 5;

FIG. 7 schematically shows stepped FMCW signals transmitted multiple radar transceiver arrangements in a vehicle;

FIG. 8 schematically shows a less detailed view of FIG. 7;

FIG. 9 schematically illustrates a traffic scenario according to the present disclosure;

FIG. 10 schematically illustrates a vehicle radar system;

FIG. 11 schematically illustrates a control unit;

FIG. 12 shows an example computer program product; and

FIG. 13 is a flow chart illustrating methods.

### DETAILED DESCRIPTION

Aspects of the present disclosure will now be described more fully with reference to the accompanying drawings. The different devices and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the disclosure. As used herein, the singular forms “a”, “an” and “the” are intended to include the plural forms as well, unless the context clearly indicates otherwise.

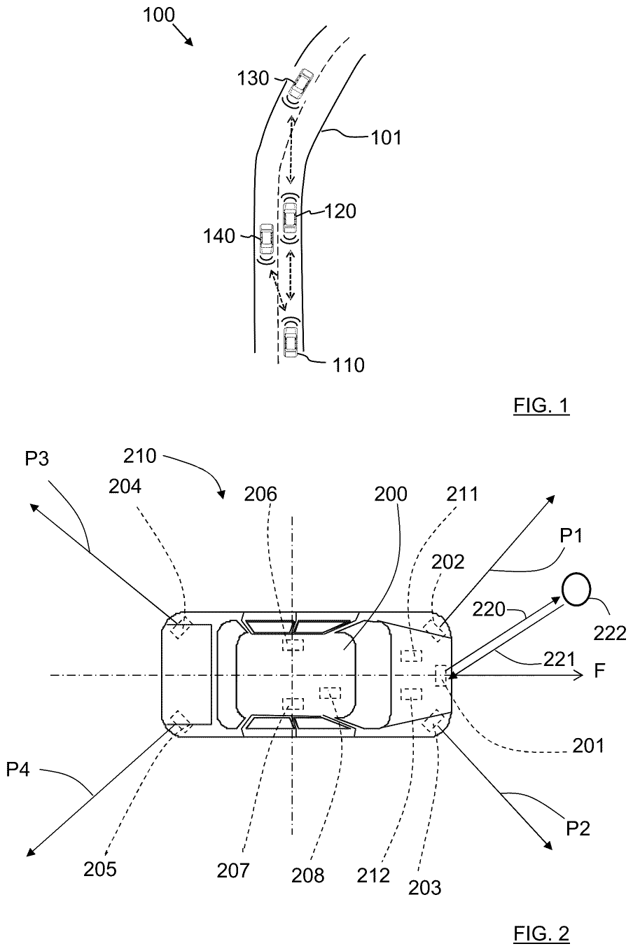

FIG. 1 shows a prior art traffic scenario 100 where vehicles 110, 120, 130, 140 travel on a road 101. Each vehicle comprises one or more radar transceivers that transmit in a common frequency band in an uncoordinated manner, which means that radar transceivers may unknowingly interfere with each other.

In FIG. 1, the front radar transceivers of vehicle 120 and vehicle 130 may generate interfere to each other, as well as the front radar transceivers of vehicle 110 and vehicle 140. Vehicle 120 also comprises rearward looking corner radar transceivers which may interfere with, e.g., the front radar transceiver of vehicle 110.

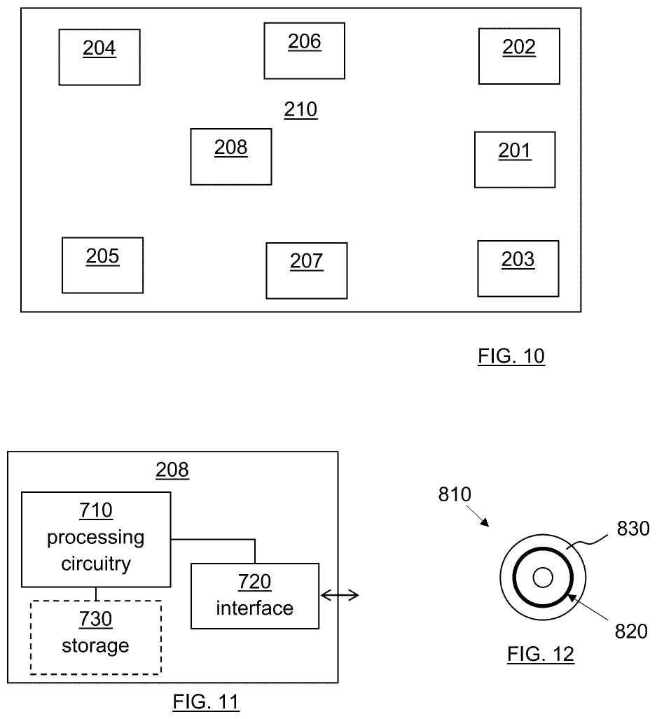

As shown in FIG. 2, there is an ego vehicle 200, having a present vehicle heading F, that comprises a vehicle radar system 210 that, as also shown in FIG. 10, in turn comprises a control unit 208 and at least one radar transceiver arrangement 201, 202, 203, 204, 205 arranged to generate and transmit an FMCW, Frequency Modulated Continuous Wave, signal 220 in a radar frequency band and to receive reflected signals 221 that have been reflected by one or more target objects 222.

Here, there is a front radar transceiver 201, a first front corner radar transceiver 202, a second front corner radar transceiver 203, a first rear corner radar transceiver 204, a second rear corner radar transceiver 205 and a control unit 208. Each corner radar transceiver 202, 203, 204, 205 is associated with a corresponding coverage main or boresight direction P1, P2, P3, P4 around which mutually different radar coverages are obtained in a known manner using FMCW chirp signals of frequency ramps.

With reference to FIG. 4, each FMCW signal 220 is in the form of a continuous sinusoid where the frequency varies from a first frequency fₛₜₐᵣₜ to a second frequency fₛₜₒₚ over the course of an ego frequency ramp r, where the magnitude of the first frequency fₛₜₐᵣₜ falls below the magnitude of the second frequency fₛₜₒₚ.

Each FMCW signal 220 thus comprises a corresponding plurality of ego frequency ramps r that are generated in radar cycles having a certain ego cycle time t_{c} and ego cycle start time t_{cs}. Each one of the ego frequency ramps r has a certain ego duration time tᵣ, ego delay time to between adjacent ego frequency ramps r and an ego frequency gradient df/dt.

According to the present disclosure, the control unit 208 is adapted to receive synchronization information from at least one external unit, and to base at least the ego cycle start time t_{cs}, the ego duration time tᵣ and the ego delay time to on the synchronization information.

In this context, an external unit is not part of the vehicle radar system 210, and is in practice positioned at a certain distance from the vehicle radar system 210. When the vehicle radar system 210 is positioned in a vehicle 200, that external unit is not part of the vehicle 200.

An external unit is according to some aspects constituted by an external radio transmitting device, or at least comprises an external radio transmitting device.

In this way, the vehicle radar system 210 may adapt the ego cycle start time t_{cs}, the ego duration time t, and the ego delay time t_{D} such that interference is minimized, while enabling frequency ramps from other radar systems 210A, 210B, 210C, 210D to be interleaved with the ego frequency ramps r in a non-interfering manner.

According to some aspects, the ego frequency gradient df/dt is based on the synchronization information.

This means that all radar transceivers adopt to a common frequency gradient or slope df/dt of their FMCW transmissions. When this common frequency gradient df/dt is used by other radar systems in other vehicles 200A, 200B, 200C, 200D, it is possible to avoid that the frequency ramps cross but can run in an interleaved non-interfering manner.

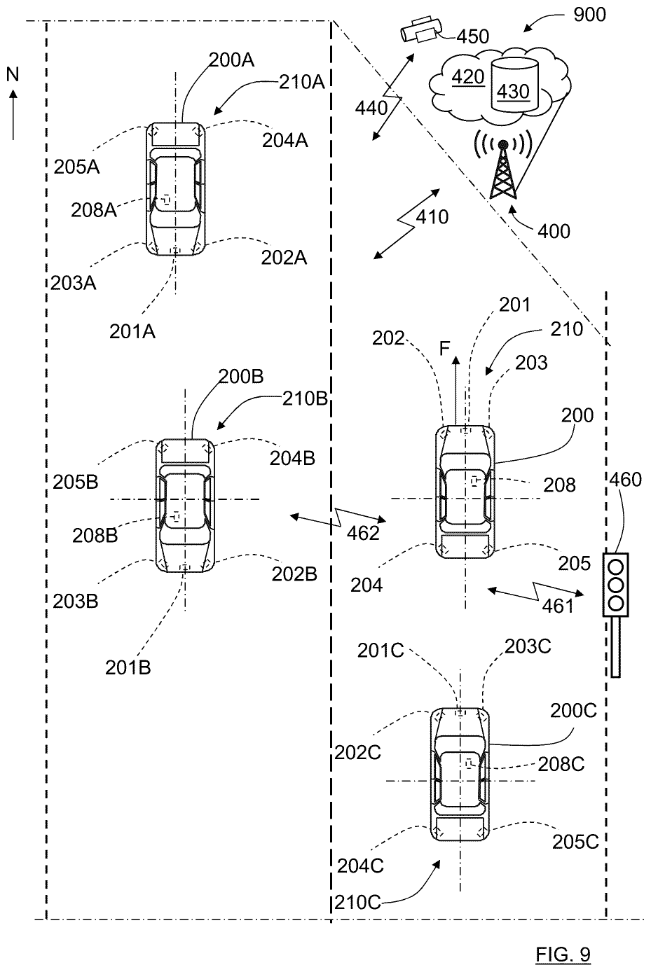

According to some aspects, with reference also to FIG. 9, external units may include a communication system 400. This may, e.g., be a third generation partnership program (3GPP) defined access network like the fourth generation (4G) or the fifth generation (5G) access networks or a satellite system such as GPS. The access network may provide access to remote networks and other resources such as, e.g., the Internet.

It is also appreciated that some processing functions may be performed by resources in a remote network 420, such as a remote server 430.

External units may also include one or more satellites 450 and neighbor control units 208A, 208B, 208C 208D that are positioned in neighbor vehicles 200A, 200B, 200C, 200D, in the latter case the communication is in the form of V2V (vehicle to vehicle) communication 462. Such V2V communication 462 could comprise information about radar transceiver timing characteristics as well as information forwarded from any other external unit such as remote servers 430 and satellites 430. In addition, external units may also include fixed infrastructure items such as traffic lights 460, road signs, etc., where the communication is in the form of V2X (vehicle to anything) communication 461. Such communication 462 could comprise environmental information as well as information forwarded from any other external unit such as remote servers 430, satellites 430 and neighbor radar systems 210A, 210B, 210C, 210D.

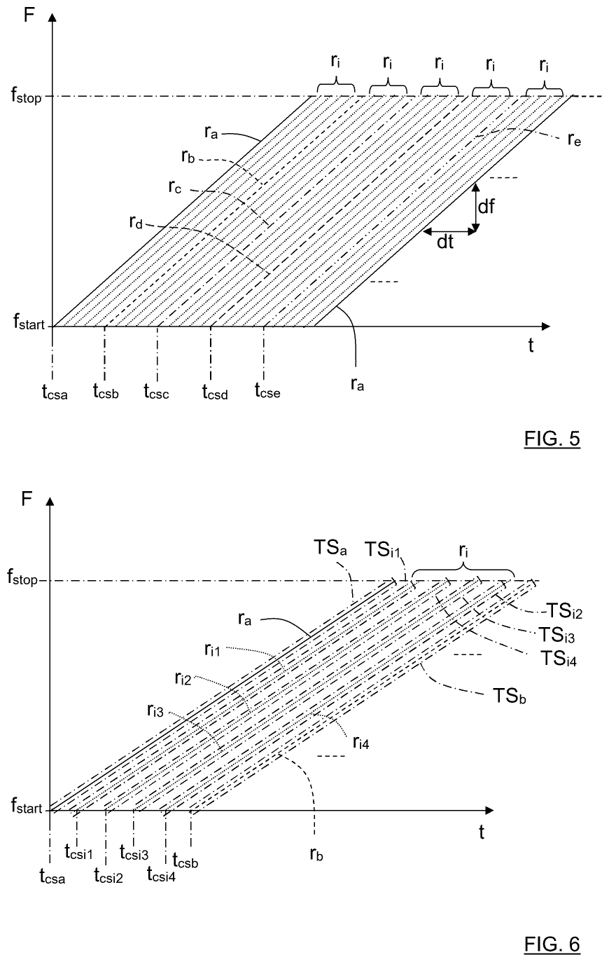

With reference to FIG. 5 and FIG. 6 that shows a detail of FIG. 5, the radar transceivers 201, 202, 203, 204, 205 are adapted to operate using defined timeslots TSₐ, TS_{b}.

In FIG. 5, the front radar transceiver 201 transmits a first series of frequency ramps rₐ with a first cycle start time t_{csa} (only two ramps shown, marked with solid lines), the first front corner radar transceiver 202 transmits a second series of frequency ramps r_{b} with a second cycle start time t_{csb} (only one ramp shown, marked with a short dashed line), the second front corner radar transceiver 203 transmits a third series of frequency ramps r_{c} with a third cycle start time t_{csc} (only one ramp shown, marked with a dashed-dotted line), the first rear corner radar transceiver 204 transmits a fourth series of frequency ramps r_{d} with a fourth cycle start time t_{csd} (only one ramp shown, marked with a long dashed line), and the second rear corner radar transceiver 205 transmits a fifth series of frequency ramps re with a fifth cycle start time t_{cse} (only one ramp shown, marked with a dashed double-dotted line).

The frequency ramps rₐ, r_{b}, r_{c}, r_{d}, rₑ, continue during their cycle times as indicated with dashed lines, all having a common frequency gradient, or slope, df/dt. Each frequency ramp rₐ, r_{b}, r_{c}, r_{d}, rₑ occupies a corresponding timeslot TSₐ, TS_{b} as illustrated for the first series of frequency ramps rₐ and the second series of frequency ramps r_{b} in FIG. 6.

FIG. 5 and FIG. 6 illustrates the timeslot structure according to the present disclosure where each timeslot corresponds to the usage of the entire bandwidth using a defined frequency gradient df/dt and cycle start time t_{cs}; t_{csa}, t_{csb}, t_{csc}, t_{csd}, t_{cse}

Offsetting the timeslots TSₐ, TS_{b} in time allows different FMCW radar transceivers to be interleaved and still ensuring sufficient spacing between the frequency ramp. This is illustrated in FIG. 5, FIG. 6 and FIG. 9.

In FIG. 9, the ego vehicle 200 is travelling in a traffic situation together with a first neighbor vehicle 200A, second neighbor vehicle 200B, third neighbor vehicle 200C and fourth neighbor vehicle 200D.

Each neighbor vehicle 200A, 200B, 200C, 200D comprises a corresponding control unit 208A, 208B, 208C, 208D, front radar transceiver 201A, 201B, 201C, 201D, first front corner radar transceiver 202A, 202B, 202C, 202D, second front corner radar transceiver 203A, 203B, 203C, 203D, first rear corner radar transceiver 204A, 204B, 204C, 204D, and second rear corner radar transceiver 205A, 205B, 205C, 205D.

In FIG. 5 and FIG. 6 there is enough space between the ego timeslots TSₐ, TS_{b} to accommodate four further intermediate timeslots TSᵢ₁, TSᵢ₂, TSᵢ₃, TSᵢ₄, where these intermediate timeslots TSᵢ₁, TSᵢ₂, TSᵢ₃, TSᵢ₄ each accommodates one intermediate frequency ramp rᵢ; rᵢ₁, rᵢ₂, rᵢ₃, rᵢ₄ each, each intermediate frequency ramp rᵢ₁, rᵢ₂, rᵢ₃, rᵢ₄ being comprised in a corresponding cycle of intermediate frequency ramps, each cycle having a corresponding cycle start time t_{csi1}, t_{csi2}, t_{csi3}, t_{csi4}. Only a few timeslots are indicated in FIG. 6 for reasons of clarity, but every frequency ramp is occupying a corresponding timeslot.

The intermediate frequency ramps rᵢ; rᵢ₁, rᵢ₂, rᵢ₃, rᵢ₄ can be transmitted from one or more of the neighboring vehicles 200A, 200B, 200C, 200D. This is enabled since the frequency gradient df/dt is the same for all frequency ramps rₐ, r_{b}, r_{c}, r_{d}, rₑ, rᵢ₁, rᵢ₂, rᵢ₃, rᵢ₄ and all cycle start times t_{csa}, t_{csb}, t_{csc}, t_{csd}, t_{cse}; t_{csi1}, t_{csi2}, t_{csi3}, t_{csi4} are synchronized accordingly. Furthermore, all frequency ramps rₐ, r_{b}, r_{c}, r_{d}, rₑ; rᵢ₁, rᵢ₂, rᵢ₃, rᵢ₄ have a common ramp time and delay time, such that all frequency ramps rₐ, r_{b}, r_{c}, r_{d}, rₑ, rᵢ₁, rᵢ₂, rᵢ₃, rᵢ₄ have similar characteristics and can be transmitted in an interleaved manner without interfering with each other.

The timeslots allow a sequence of for example 32 chirps, or frequency ramps, to be sent by different radar transceiver within a 64 μs “frame” period. The timeslots are then repeated in the next frame.

This is all enabled by the control unit 208 being adapted to receive synchronization information from at least one external unit as described above, and preferably all control units 208, 208A, 208B, 208C, 208D are adapted to receive the synchronization information.

According to some aspects, the synchronization information comprises time reference data, where the control unit 208 is adapted to control the ego cycle start time t_{cs}; t_{csa}, t_{csb}, t_{csc}, t_{csd}, t_{cse} in dependence of the time reference data.

The accurate start time of each slot may according to some aspects be derived by a GNSS signal and this may be distributed accurately to radar transceivers around the vehicle, for example using PTP.

According to some aspects, the synchronization information comprises a frequency reference, where the control unit 208 is adapted to control at least one radar transceiver arrangement 201, 202, 203, 204 205 to generate ego frequency ramps r; rₐ, r_{b}, r_{c}, r_{d}, rₑ in dependence of the frequency reference.

The use of external frequency reference would ensure that the chirp or frequency ramp gradient is maintained precisely as if the gradient or timing is slightly wrong then over the course of multiple chirps two chirp signals may become too close together and cause interference.

By using an externally derived timing reference, all radar systems within an area can maintain the same slope gradient as well as fixed starting frequencies. By defining a set of fixed starting times, for example at 2 μs intervals one can define a set of “timeslots”. In this context, the timeslots would be defined by their start time and starting frequency. The periodicity would be fixed, for example at 64 μs such that a block of chirps all occupying the same timeslot could be sent and in such an example there would be 32 timeslots to choose from. Different radar transceivers around the vehicle and in neighbouring vehicles can select a timeslot to avoid interference. An external observer would see all radar transceivers operating at the same time and in the same band, in an interleaved pattern.

According to some aspects, the synchronization information comprises information regarding at which times tₛᵢ₁, t_{csi2}, t_{csi3}, t_{csi4} neighboring radar transceivers are transmitting neighboring frequency ramps rᵢ; rᵢ₁, rᵢ₂, rᵢ₃, rᵢ₄ and with which neighboring frequency gradient df/dt. The control unit 208 is adapted to control the ego frequency gradient df/dt to correspond to the synchronization information and to schedule the ego frequency ramps r; rₐ, r_{b}, r_{c}, r_{d}, rₑ in free timeslots between the neighboring frequency ramps rᵢ; rᵢ₁, rᵢ₂, rᵢ₃, rᵢ₄.

In this way, neighboring frequency ramps rᵢ; rᵢ₁, rᵢ₂, rᵢ₃, rᵢ₄ can be interleaved with ego frequency ramps r; rₐ, r_{b}, r_{c}, r_{d}, rₑ in a non-interfering manner.

According to some aspects, the control unit 208 is adapted to control at least one radar transceiver arrangement 201, 202, 203, 204, 205 to monitor a certain part of the radar frequency band during an observation period, to analyze possible interference signals rᵢ; rᵢ₁, rᵢ₂, rᵢ₃, rᵢ₄, and to identify a certain start time t_{cs}; t_{csa}, t_{csb}, t_{csc}, t_{csd}, t_{cse} to start sending a cycle of one or more ego frequency ramps r; rₐ, r_{b}, r_{c}, r_{d}, rₑ in dependence of said analysis, such that interference from said interference signals rᵢ; rᵢ₁, rᵢ₂, rᵢ₃, rᵢ₄ is reduced.

For example, the radar system 210 could monitor the first 64 μs of a cycle in order to select the best timeslot and then start transmission for one or more radar transceivers 201, 202, 203, 204, 205. Said radar transceiver 201, 202, 203, 204, 205 may for that reason forgo that first chirp of its cycle, or may extend the transmission to obtain a full set of chirps.

According to some aspects, the control unit 208 is adapted to receive information from neighboring control units 208A, 208B, 208C, 208D regarding neighboring timeslots TSᵢ₁, TSᵢ₂, TSᵢ₃, TSᵢ₄, and to determine an ego timeslot structure with corresponding ego timeslots TS_{A}, TS_{B}; TS₁, TS₉, TS₁₇.

The radar frequency band can thus be monitored to determine which timeslots that are occupied and which are free. The control unit 208 may then control the radar transceiver arrangements 201, 202, 203, 204, 205 to transmit on that timeslot for one or more radar cycles, periodically checking that the timeslot is still free. Alternatively timeslots may be changed in a random fashion.

According to some embodiments, the control unit 208 is adapted to control at least one radar transceiver arrangement 201, 202, 203, 204, 205 to monitor a random number of frames before selecting its timeslot within the Nth frame. Typically, radar transceivers do not transmit for the whole cycle time of for example 50 ms. In fact they may often only transmit for example 40% of the cycle. Hence it is never critical that radar transceivers start transmitting at exactly the same start time. Having selected a timeslot, the radar would then use that timeslot for the next M cycles starting at the beginning of the frame. This would give other radar transceivers that were monitoring the first 64 μs to select their timeslot with due warning that the timeslot was already in use.

In other embodiments, the 50 ms cycle is divided into two sub-periods each of 25 ms. A radar transceiver may only transmit on one of the two sub-periods. Again, the sub-periods would derive their timing from an external source.

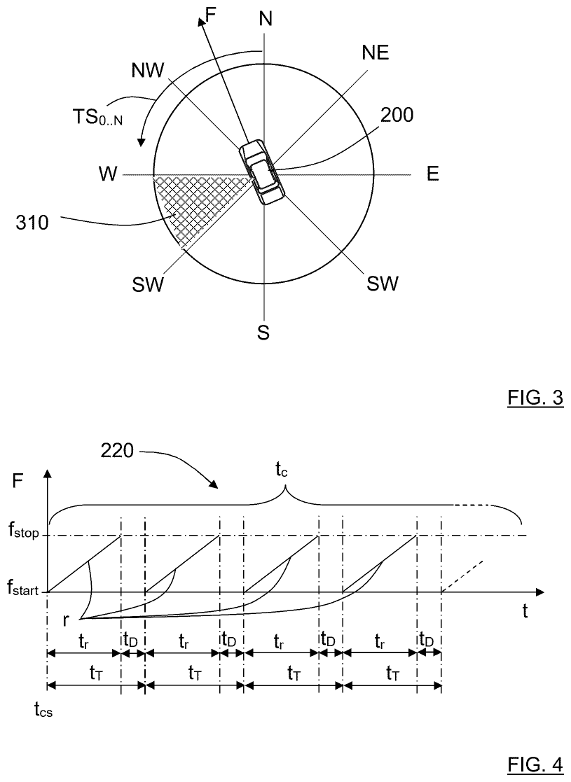

According to some aspects, with reference to FIG. 2 and FIG. 3, each radar transceiver arrangement 201, 202, 203, 204, 205 is associated with a main pointing direction F, P1, P2, P3, P4 and a pre-defined set of timeslots 0 . . . N, where each timeslot TS_{0.N} corresponds to a sequence of ego frequency ramps rₐ, r_{b}, r_{c}, r_{d}, ᵣₑ within a frame and the timeslot number corresponds to a time offset. The control unit 208 is adapted to:
define heading intervals 310 which divide a full turn interval 0-360° into sections 310,
assign a corresponding timeslot to each heading interval 310,
determine a present vehicle heading F, and to
assign a corresponding timeslot to each one of the radar transceivers 201, 202, 203, 204, 205 in dependence of the heading interval 310 that comprises the present vehicle heading F.

This way, only those radar transceivers that are likely to interfere are controlled to generate interleaved frequency ramps.

According to some aspects, the control unit 208 is adapted to determine a present vehicle heading by means of GNSS (Global Navigation Satellite System) or magnetic compass data.

According to some aspects, the control unit is adapted to determine a present vehicle heading by determining a predominant road extension direction.

In FIG. 3, for reasons of clarity only one heading interval/section 310 is indicated. Normally there is a plurality of heading intervals/sections along the full turn interval 0-360°.

In this way, unwanted toggling is avoided.

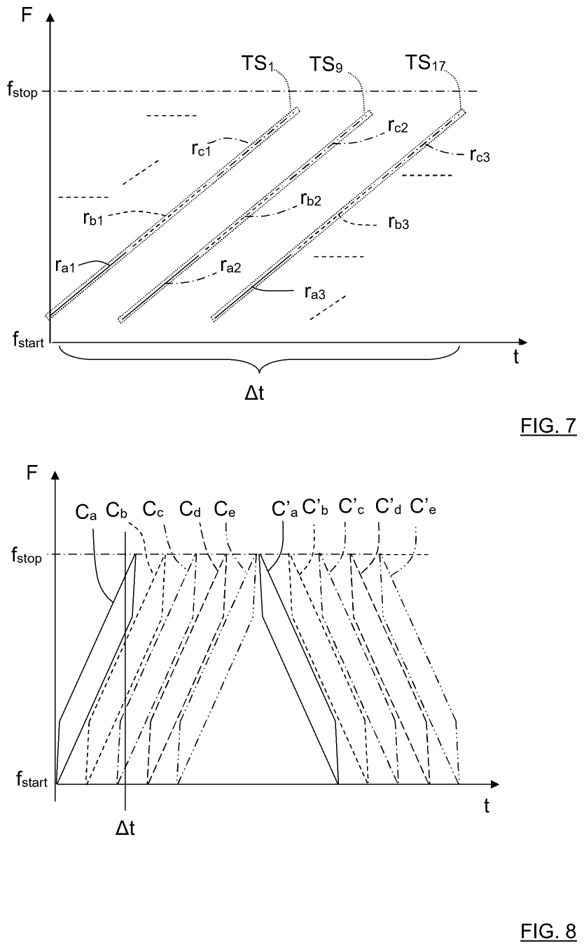

FIG. 7 illustrates a stepped FMCW signal transmitted by the radar transceivers 201, 202, 203, 204, 205. A stepped FMCW signal is typically transmitted in shorter chirps, but from chirp to chirp the centre frequency changes in a linear fashion.

In FIG. 7, there are stepped frequency ramps where a first stepped frequency ramp is constituted by a first ramp rₐ₁ from the first series of frequency ramps rₐ, a first ramp r_{b1} from the second series of frequency ramps r_{b}, and a first ramp r_{c1} from the third series of frequency ramps r_{c}. In the same manner there is a second stepped frequency ramp rₐ₂, r_{b2}, r_{c2} and a third stepped frequency ramp rₐ₃, r_{b3}, r_{c3}.

FIG. 7 is a detail of FIG. 8 that illustrates stepped frequency radar cycles Cₐ, C_{b}, C_{c}, C_{d}, Cₑ for all the radar transceivers 201, 202, 203, 204, 205. A time window Δt of FIG. 8 is illustrated in FIG. 7.

According to some aspects, generally, the radar transceiver arrangements 201, 202, 203, 204, 205 are adapted to transmit a stepped FMCW waveform whereby the radar transceiver arrangements 201, 202, 203, 204, 205 are synchronised such that the corresponding ego frequency ramps rₐ, r_{b}, r_{c}, r_{d}, rₑ are aligned to occupy one timeslot TS₁, TS₉, TS₁₇ each.

In this example, each of the stepped frequency ramps occupy a corresponding timeslot TS₁, TS₇, TS₁₇, where there are 8 free timeslots between each stepped frequency ramp. This means that it is possible to fit eight intermediate stepped frequency ramps between each stepped frequency ramp rₐ₁, r_{b1}, r_{c1}; rₐ₂, r_{b2}, r_{c2}; rₐ₃, r_{b3}, r_{c3} in the same manner as described previously.

This means that the present disclosure is applicable for stepped frequency ramps as well.

In FIG. 7 and FIG. 8, the radar transceivers 201, 202, 203, 204, 205 from the same vehicle 200 are accurately time synchronised such that they occupy a minimum number of timeslots, which were defined previously for the FMCW radar. Note that the gradient is still the same and thus a stepped FMCW radar and an FMCW radar could interleave their signals and avoid interference with each other.

Interleaving could still work even if the radar transceivers 201, 202, 203, 204, 205 from the same vehicle 200 would not be accurately time synchronised, each stepped frequency ramp would occupy many timeslots thus reducing the number of intermediate stepped frequency ramps that can be interleaved between the stepped frequency ramps rₐ₁, r_{b1}, r_{c1}; rₐ₂, r_{b2}, r_{c2}; rₐ₃, r_{b3}, r_{c3}.

A system of stepped FMCW signals would need to occupy more timeslots than a regular FMCW radar because the chirps, being shorter, are also closer together.

Some vehicle systems may use a stepped FMCW radar waveform, which only occupies a part of the 1GHz band for any one chirp. In such stepped FMCW systems, multiple radar transceivers around the vehicle may be transmitting at the same time, but in different parts of the band.

According to some aspects, all stepped FMCW radar transceivers around the vehicle are synchronised in time and frequency such that the radar chirps appear as a near single continuous chirp and hence still occupy a small number of timeslots. This allows regular FMCW and stepped FMCW radar transceivers to avoid interference with each other.

According to some aspects, the slope of the timeslots TS₁, TS₉, TS₁₇ is positive in some stepped frequency radar cycles Cₐ-Cₑ and negative in some stepped frequency radar cycles C′ₐ-C′ₑ.

In other words, FIG. 8 also highlights a potential problem created by stepped FMCW radar transceivers which is that in some implementations their stepping direction is not always positive. It may be necessary to impose only a positive stepping direction. Alternatively, the timeslots could be devised such that in even cycle numbers 0, 2, 4, etc the timeslot represents a positive gradient and in odd timeslots number 1, 3, 5, etc. negative gradient slopes could be defined. In such a case, the FMCW radar transceivers would also need to observe this convention and alternate their chirping directions.

One way for such a system to operate would be using an externally deriving timing reference as mentioned above, which may for example be from GNSS. In such cases, the control unit 208 may receive the GNSS signal and distribute this to the radar transceivers 201, 202, 203, 204, 205. Alternatively the control unit 208 may directly control the chirp timing as well as frequency. Radar transceivers 201, 202, 203, 204, 205 around the vehicle 200 typically use a crystal oscillator with a precision on the order of 50 parts per million. Hence even if the start time of the chirp is precise, there may be an offset in the frequency. For this reason under some embodiments the radar transceivers 201, 202, 203, 204, 205 use the timing reference to correct their internal clocks. For example if the radar could determine the clock error and correct the frequency controlling parameters accordingly such that the start frequency was always precise.

The radar transceivers 201, 202, 203, 204, 205 may operate using such a timeslot structure without the use of a GNSS reference and in such cases they could monitor the surrounding signals and select a timeslot in the same way. However such a system would be less precise and the timeslots may not be used as efficiently. Similarly in some situations the GNSS signal may be lost temporarily or for a longer time, such as in a tunnel and in such cases the radar transceivers 201, 202, 203, 204, 205 would need to use their best estimates of the last good timing and be aware that their neighbouring vehicles would have similar limitations.

The described method may still operate quite well if a small percentage of the vehicles in the population did not have the external timing reference, but based the timing only on listening to the structure of the other radar transceivers that did use the frequency reference. There would still be benefit in the radar transceivers from using the same gradient without timing reference. In fact, those vehicles may be able to synchronise to the chirp of other external radar transceivers using for example a phase locked loop and hence derive their own internal frequency and timing reference.

The selection of timeslots may therefore, according to some aspects, be based on listen before talk or could be based either on the direction of the vehicle or based on the pointing direction of the radar transceivers 201, 202, 203, 204, 205 as discussed above. For example if the radar transceiver 201, 202, 203, 204, 205 is pointing in a northerly direction, then the radar could select a timeslot from the set of 0, 8, 16 or 24. If the radar transceiver 201, 202, 203, 204, 205 was facing west then it could select from timeslots 2, 10, 18, 26, etc. In this way a system could be developed that would be compatible both with FMCW and stepped FMCW radar transceivers.

It may be that the defined total number of timeslots is different to 32 however the number 32 is used in this disclosure as one example.

According to some aspects, all radar transceivers within a vehicle may be synchronised in time and possibly also frequency using a protocol such as PTP. The selection of the timeslot may be based on first monitoring the band for a period of for example 64 μs before selecting a timeslot and starting transmissions or alternatively be based on the compass direction of the main beam of the radar, for example a radar pointing due north may use timeslot 0, a radar pointing due west may use timeslot 8, etc. In other words the timeslot number could be calculated directly from the direction of the radar in degrees relative to due north.

FIG. 11 schematically illustrates, in terms of a number of functional units, the components of the control unit 208 according to an embodiment.

Processing circuitry 710 is provided using any combination of one or more of a suitable central processing unit (CPU), multiprocessor, microcontroller, digital signal processor (DSP), dedicated hardware accelerator, etc., capable of executing software instructions stored in a computer program product, e.g. in the form of a storage medium 730. The processing circuitry 710 may further be provided as at least one application specific integrated circuit (ASIC), or field programmable gate array (FPGA).

Particularly, the processing circuitry 710 is configured to cause the control unit 208 to perform a set of operations, or steps. These operations, or steps, were discussed above in connection to the various radar transceivers and methods. For example, the storage medium 730 may store the set of operations, and the processing circuitry 710 may be configured to retrieve the set of operations from the storage medium 730 to cause the control unit 208 to perform the set of operations. The set of operations may be provided as a set of executable instructions. Thus, the processing circuitry 710 is thereby arranged to execute methods and operations as herein disclosed.

The storage medium 730 may also comprise persistent storage, which, for example, can be any single one or combination of magnetic memory, optical memory, solid state memory or even remotely mounted memory.

The control unit 208 may further comprise a communications interface 720 for communications with at least one other unit. As such, the radar interface 720 may comprise one or more transmitters and receivers, comprising analogue and digital components and a suitable number of ports for wired or wireless communication.

The processing circuitry 710 is adapted to control the general operation of the control unit 208 e.g. by sending data and control signals to the external unit and the storage medium 730, by receiving data and reports from the external unit, and by retrieving data and instructions from the storage medium 730. Other components, as well as the related functionality, of the control unit 208 are omitted in order not to obscure the concepts presented herein.

Generally, the control unit 208 is adapted to communicate with at last one external unit 400, 420, 430, 450. This can for example be enabled by means of a satellite receiver 206 and/or a cellular network receiver 207 which are comprised in the radar system 210 as shown in FIG. 10, and which are connected to the communications interface 720.

FIG. 12 shows a computer program product 810 comprising computer executable instructions 820 arranged on a computer readable medium 830 to execute any of the methods disclosed herein.

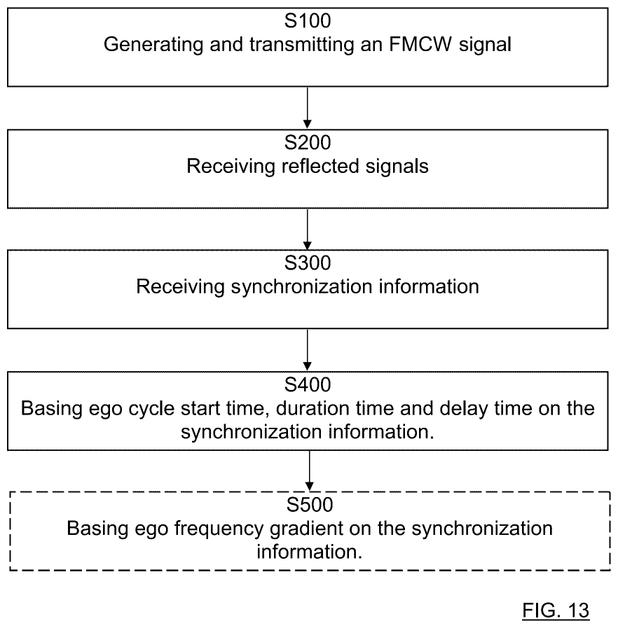

With reference to FIG. 13, the present disclosure also relates to a method in vehicle radar system 210; 210A, 210B, 210C. The method comprises generating and transmitting S100 an FMCW, Frequency Modulated Continuous Wave, signal 220 in a radar frequency band using at least one radar transceiver arrangement 201, 202, 203, 204, 205, and receiving S200 reflected signals 221 that have been reflected by one or more target objects 222.

Each FMCW signal 220 comprises a corresponding plurality of ego frequency ramps r; rₐ, r_{b}, r_{c}, r_{d}, rₑ that are generated in radar cycles having a certain ego cycle time to and ego cycle start time t_{cs}, t_{csa}, t_{csb}, t_{csc}, t_{csd}, t_{cse}. Each one of the ego frequency ramps r; rₐ, r_{b}, r_{c}, r_{d}, rₑ has a certain ego duration time tᵣ, an ego delay time to between adjacent ego frequency ramps r and an ego frequency gradient df/dt.

The method further comprises receiving S300 synchronization information from at least one external unit 400, 420, 430, 450; 208A, 208B, 208C; 460, and basing S400 at least the ego cycle start time t_{cs}; t_{csa}, t_{csb}, t_{csc}, t_{csd}, t_{cse}, the ego duration time tᵣ and the ego delay time t_{D} on the synchronization information.

According to some aspects, the method comprises basing S500 the ego frequency gradient df/dt on the synchronization information.

According to some aspects, the synchronization information comprises time reference data, where the method comprises controlling the ego cycle start time t_{cs}, t_{csa}, t_{csb}, t_{csc}, t_{csd}, t_{cse} in dependence of the time reference data.

According to some aspects, the synchronization information comprises a frequency reference, where the method comprises controlling at least one radar transceiver arrangement 201, 202, 203, 204 205 to generate ego frequency ramps r; rₐ, r_{b}, r_{c}, r_{d}, rₑ in dependence of the frequency reference.

Each radar system 210, 210A, 210B, 210C is adapted to monitor the radar band in one or more of the pre-defined timeslots to determine the best timeslot to select for transmissions. The timeslot corresponding to a periodic allocation within a defined period.

According to some aspects, the present disclosure relates to a common vehicle radar system 900 comprising at least two separate radar systems 210; 210A, 210B, 210C, 210D.

Each radar system 210; 210A, 210B, 210C, 210D comprises a control unit 208 and at least one radar transceiver arrangement 201, 202, 203, 204 205 arranged to generate and transmit an FMCW, Frequency Modulated Continuous Wave, signal 220 and to receive reflected signals 221 that have been reflected by one or more target objects 222. The FMCW signal 220 comprises a corresponding plurality of frequency ramps r; rₐ, r_{b}, r_{c}, r_{d}, rₑ; rᵢ that are generated in radar cycles having a certain cycle time to and cycle start time t_{cs}; t_{csa}, t_{csb}, t_{csc}, t_{cs}d, t_{cse}; t_{csi1}-t_{csi4}. Each one of the frequency ramps r has a certain duration time tr, delay time to between adjacent the frequency ramps r and frequency gradient df/dt. All the ramps r; rₐ, r_{b}, r_{c}, r_{d}, rₑ; rᵢ generated in the vehicle radar system share the same duration time tr, delay time to, cycle time to, and frequency gradient df/dt, where, for each radar transceiver arrangement, each cycle start time t_{cs}; t_{csa}, t_{csb}, t_{csc}, t_{csd}, t_{cse}; t_{csi1}-t_{csi4} is different.

According to some aspects, the present disclosure relates to a radar system 210 for a vehicle 200, comprising a plurality of radar transceivers 202, 203, 204, 205 and a control unit 208. Each radar transceiver 202, 203, 204, 205 occupies one or more of a defined set of interleaved timeslots to avoid interference and to minimise interference to neighbouring vehicles. The timeslot allows the UE to send multiple chirps periodically within one radar cycle.

In the case of stepped FMCW radar, the radar transceivers within the vehicle also occupy a minimum set of timeslots by ensuring their start times and start frequencies are precisely controlled within a vehicle. The timing reference and optionally also the starting frequency of each timeslot would be obtained from an external frequency reference, e.g. GNSS. The timeslot used by each radar may be determined by each radar using a listen-before-talk approach or using the compass direction of the vehicle.

The present disclosure is not limited to the above, but may vary freely within the scope of the appended claims. For example, each control unit 208; 208A, 208B, 208C, 208D may be in the form of a control unit arrangement that is constituted by one or more control unit parts that can be separate from each other. Some or all control unit parts may be comprised in a corresponding radar transceiver 201, 202, 203, 204, 205 and/or remote server 430.

When the radar transceivers 201, 202, 203, 204, 205 are positioned in a vehicle 200, the control unit 208 is according to some aspects at least partly positioned in the same vehicle.

Each radar transceiver can also be regarded as a radar transceiver arrangement.

Chirp, radar chirp and frequency ramp are normally mutually equivalent regarding technical meaning in the present context.

1. A vehicle radar system comprising: a control unit and at least one radar transceiver arrangement arranged to generate and transmit, a Frequency Modulated Continuous Wave (FMCW) signal in a radar frequency band and to receive reflected signals that have been reflected by one or more target objects,
where each FMCW signal comprises a corresponding plurality of ego frequency ramps that are generated in radar cycles having a certain ego cycle time and ego cycle start time,
where each one of the ego frequency ramps has a certain ego duration time, an ego delay time between adjacent ego frequency ramps, and an ego frequency gradient,
wherein the control unit is adapted to receive synchronization information from at least one external unit, and to base at least the ego cycle start time time the ego duration time and the ego delay time on the synchronization information.

2. The vehicle radar system according to claim 1, wherein the ego frequency gradient is based on the synchronization information.

3. The vehicle radar system according to claim 1, wherein the synchronization information comprises time reference data, where the control unit is adapted to control the ego cycle start time in dependence of the time reference data.

4. The vehicle radar system according to claim 1, wherein the synchronization information comprises a frequency reference, where the control unit is adapted to control at least one radar transceiver arrangement to generate ego frequency ramps in dependence of the frequency reference.

5. The vehicle radar system according to claim 1, wherein the synchronization information comprises information regarding at which times neighboring radar transceivers are transmitting neighboring frequency ramps and with which neighboring frequency gradient where the control unit is adapted to control the ego frequency gradient to correspond to the synchronization information and to schedule the ego frequency ramps in free timeslots between the neighboring frequency ramps.

6. The vehicle radar system according to claim 1, wherein the control unit (208) is adapted to:
control at least one radar transceiver arrangement to monitor a certain part of the radar frequency band during an observation period;
analyze possible interference signals; and to
identify a certain start time to start sending a cycle of one or more ego frequency ramps in dependence of said analysis, such that interference from said interference signals is reduced.

7. The vehicle radar system according to claim 1, wherein the control unit is adapted to receive information from neighboring control units regarding neighboring timeslots and to determine an ego timeslot structure with corresponding ego timeslots.

8. The vehicle radar system according to claim 1, wherein each radar transceiver arrangement is associated with a main pointing direction and a pre-defined set of timeslots 0 . . . N, where each timeslot corresponds to a sequence of ego frequency ramps within a frame and the timeslot number corresponds to a time offset, where the control unit is adapted to:
define heading intervals which divide a full turn interval 0-360° into sections,
assign a corresponding timeslot to each heading interval,
determine a present vehicle heading, and to
assign a corresponding timeslot to each one of the radar transceivers in dependence of the heading interval that comprises the present vehicle heading.

9. The vehicle radar system according to claim 1, wherein the radar transceiver arrangements are adapted to transmit a stepped FMCW waveform whereby the radar transceiver arrangements are synchronised such that the corresponding ego frequency ramps are aligned to occupy one timeslot each.

10. The vehicle radar system according to claim 9, wherein the slope of the timeslots is positive in some stepped frequency radar cycles and negative in some stepped frequency radar cycles.

11. A method for a vehicle radar system, the method comprising:
generating and transmitting an FMCW, Frequency Modulated Continuous Wave, signal in a radar frequency band using at least one radar transceiver arrangement; and
receiving reflected signals that have been reflected by one or more target objects;
where each FMCW signal comprises a corresponding plurality of ego frequency ramps that are generated in radar cycles having a certain ego cycle time and ego cycle start time where each one of the ego frequency ramps has a certain ego duration time, an ego delay time between adjacent ego frequency ramps and an ego frequency gradient
wherein the method further comprises:
receiving synchronization information from at least one external unit, and
basing at least the ego cycle start time, the ego duration time and the ego delay time on the synchronization information.

12. The method according to claim 11, wherein the method comprises basing the ego frequency gradient on the synchronization information.

13. The method according to claim 11, wherein the synchronization information comprises time reference data, where the method comprises controlling the ego cycle start time in dependence of the time reference data.

14. The method according to claim 11, wherein the synchronization information comprises a frequency reference, where the method comprises controlling at least one radar transceiver arrangement to generate ego frequency ramps in dependence of the frequency reference.

15. A vehicle comprising the vehicle radar system according to claim 1.
